(19) United States
(12) Patent Application Publication
(10) Pub. No.: US 2004/0028444 A1
(43) Pub. Date: Feb. 12, 2004

(54) Printing machine with adjusting device for synchronizing the photoconductor and feed guides by means of a master-slave controller

(76) Inventors: Bernd Schultheis, Schwabenheim (DE); Dieter Jung, Daaden (DE); Birgit Lattermann, Ried-Stadt (DE); Hermann Lemm, Dellhofen (DE)

Correspondence Address: Pauley Petersen Kinne & Erickson, 2800 W Higgins Road Suite 365, Hoffman Estates, IL, 60195, US

(21) Appl. No.: 10/363,884

(22) PCT Filed: Sep. 18, 2001
(86) PCT No.: PCT/EP01/10756

(30) Foreign Application Priority Data
Oct. 20, 2000 (DE) 100523056

(51) Int. Cl. B41J 2/00

(52) U.S. Cl. 400/118.2

(57) ABSTRACT

A printing machine with an electrophotographic device, having a photoconductor, a photoconductor drive and an illumination device. The electrophotographic unit can be provided with the substrate by a feed device. The photoconductor drive motor is adjusted by a controller and the feed device can be linearly adjusted by a feed device drive motor. In order to produce high-definition prints, especially images or lettering on plate-shaped substrates, the feed device drive motor is adjusted by a controller that is controlled by a master-slave controller via a setpoint feed. The controller for the photoconductor drive motor is also controlled by the master-slave controller via a setpoint feed and the master slave controller synchronizes the feeding speed of the feed device and the speed of movement of the photoconductor.

The invention relates to a printing device, having an electro-photographic arrangement with a photoconductor, to which a photoconductor drive motor and an illuminating unit are assigned, wherein the substrate can be conveyed to the electro-photographic unit by means of a conveying device, wherein the photoconductor drive motor can be controlled by means of a control device, and wherein the conveying device can be linearly displaced by means of a drive motor for the conveying device.

Such a printing device is known from EP 0 834 784 A1. There, the electro-photographic arrangement has an endlessly revolving belt as the transfer medium. Different electro-photographic units, each with a photoconductor, are assigned to this belt. Toner material can be applied to the belt via the photoconductor. A transport system, which is being linearly displaced, is provided for imprinting plate-shaped workpieces. The workpiece is in contact with the belt during the transporting process. In the course of this, the toner material is transferred from the belt to the surface of the workpiece. For being able to create images with sharp contours on the surface of the workpiece, it is necessary to adapt the speed of revolution of the belt to the feed speed of the transporting system.

Exact drive mechanisms are required in particular in case of imprinting plate-shaped materials, for example made of glass or plastic, and where high demands are made on sharp contours, positioning accuracy and least possible amount of distortion.

It is therefore the object of the invention to produce a printing device of the type mentioned at the outset, by means of which it is possible to create sharp-contoured, undistorted imprints, in particular on plate-shaped substrate.

This object is attained in that the drive motor of the conveying device can be controlled by means of a regulator, which is actuated by a master-slave controller via a set value feed line, that the control device for the drive motor of the photoconductor is also actuated by the master-slave controller via a set value feed line by means of a regulator, and that the master-slave controller synchronizes the feed speed of the conveying device and the movement speed of the photoconductor.

It is possible by means of this arrangement to match the drive speed of the drive motor of the conveying device and of the drive motor of the photoconductor, so that a relative speed is no longer created between the photoconductor and the surface to be imprinted, which would cause smearing of the toner image. In this way it is in particular possible to apply writing or images to plate-shaped workpieces.

In accordance with a preferred embodiment of the invention it is provided in connection with the electro-photographic printing device that an incremental transducer and/or pulse former is assigned to the drive motor of the photoconductor, that the incremental transducer and/or pulse former feeds the movement speed of the drive motor of the photoconductor back to the master-slave controller via a signaling path, and that the signal generated by the incremental transducer and/or the pulse former is wired up for controlling the writing speed of the exposure unit. In this way it is possible to use the control circuit for synchronizing the drive motor of the conveying device and the drive motor of the photoconductor also for controlling the exposure unit. In this case the technical outlay is very small, because it is only necessary to pick up the signal from the incremental transducer and/or pulse former and to supply it to the exposure unit.

In this connection it is possible in particular to provide that the incremental transducer and/or pulse former of the drive motor of the photoconductor feeds a master signal back to the master-slave controller via a signaling path, and that the master-slave controller controls the drive motor of the conveying device as a function of this master signal.

However, it is also conceivable that motor of the conveying device generates a signal for controlling the writing speed of the exposure unit. In this case it is then possible in particular to feed a signal back from this drive motor of the conveying device, which is then employed for controlling the drive motor of the photoconductor.

A simply wired and dependably operating control circuit results if it is provided that the master-slave controller transmits a set value signal to a regulator for controlling the drive motor of the conveying device and/or the drive motor of the photoconductor, that the regulator controls the voltage required for the drive motor of the conveying device and/or the drive motor of the photoconductor, that a resolver is assigned to the drive motor of the conveying device and/or the drive motor of the photoconductor, which feeds back an actual value motor signal to the master-slave controller via an incremental transducer and/or pulse former. The control circuits for the drive motor of the conveying device and/or the drive motor of the photoconductor are preferably identically designed, so that identical components can be used.

The incremental transducer and/or pulse former can be electrically or mechanically coupled with the resolver. In case an electrically operated resolver is used, it is advantageously assigned to the regulator. A printing device in accordance with the invention can be designed in such a way that the master-slave controller has an interface for a programming field, or its own programming field, by means of which the control parameters can be changed. In that case it is possible, for example, to set the synchronized running parameters, the motor speed or the ramp, over which the drive motor for the conveying device or for the photoconductor is triggered, by means of the master-slave controller.

In what follows, the invention will be explained in greater detail by means of an exemplary embodiment represented in the drawings. The drawings show a wiring diagram of a control arrangement for an electro-photographic copier. The control arrangement has a programming field 10, by means of which an SPS 11 (memory-programmable control) can be set. The SPS 11 is in contact with a master-slave controller 13. A further programming field 12 is assigned to the latter. Via the programming field 12 it is possible to program the master-slave controller 13 with various control parameters.

A regulator 14 is connected with the master-slave controller 13 via a set value feed line 18.1. In turn, a drive motor 15 of the conveying device is assigned to the regulator 14. The motor 15 is connected to the regulator 14 via a motor control line 18.2 and is provided with a voltage by it. A resolver 16 is mechanically connected to the drive motor 15 of the conveying device, for which a resolver drive mechanism 18.3 is used. The resolver 16 is in contact with an incremental transducer and/or pulse former 14.1 via the signaling path 18.5. This incremental transducer and/or pulse former 14.1 is assigned to the regulator 14 and can be electrically programmed. A signal line 18.6 branches off the incremental transducer and/or pulse former 14.1, which is in electrical contact with an actual value feed line 18.8. This actual value feed line 18.8 is conducted to the master-slave controller 13. Alternatively to the incremental transducer and/or pulse former 14.1, it is also possible to employ an incremental transducer and/or pulse former 17, which is mechanically coupled with the resolver 16 via a pulse transducer drive mechanism 18.4. In that case this pulse transducer 17 is in contact with the actual value feed line 18.8 via the signal line 18.7.

The same as the drive motor 15 of the conveying device, the drive motor 21 of the photoconductor device is in control contact with the master-slave controller 13. In this case the control circuits of the drive motor 15 of the conveying device and the drive motor 21 of the photoconductor device are identically designed. In accordance with this, a set value is fed by the master-slave controller 13 to a regulator 20 via a set value feed line 24.1. The regulator 20 controls the drive motor 21 of the photoconductor device via the motor control line 24.2. The motor in turn is in contact with a resolver 22 via a resolver drive mechanism 24.3. Via a set value feed line 24.8, the resolver 22 is in contact with an incremental transducer and/or pulse former 20.1, which is assigned to the regulator 20 via a signal line 24.6, or via an incremental transducer and/or pulse former 23, which is coupled to the resolver 22 via a pulse transducer drive mechanism 24.4. The set value feed line 24.8 is finally connected to the master-slave controller 13.

A control line 33.1 is branched off the actual value feed line 24.8. It leads to a personal computer 30. The personal computer 13 controls a controller 31. The controller 31 in turn controls an exposure unit 32.

In the present control diagram, a master signal is fed by the master-slave controller to the regulator 20 via the set value feed line 24.1. The latter supplies the drive motor 21 of the photoconductor with electrical current in accordance with this master signal via the motor control line 24.2. The resolver 22 feeds the actual motor speed in the form of sine pulses back to the pulse transducer 20.1 or 23. The pulses generated by the pulse transducer 20.1 or 23 provide the master-slave controller with information regarding the actual motor speed of the drive motor 21 of the photoconductor. The master-slave controller 13 controls the drive motor 15 of the conveying device on the basis of its knowledge of the speed of the drive motor of the photoconductor. In this way it is possible to synchronize the speed of the drive motor 15 of the conveying device in respect to the speed of the drive motor 21 of the photoconductor.

The control line 33.3 accesses the actual value feed line 24.8. It is possible in this way to process the actual speed value of the drive motor 21 of the photoconductor in the personal computer 30 and the controller 31. Finally, it is possible by means of this to adjust the writing speed of the exposure unit 32 as a function of the speed of the drive motor 21 of the photoconductor.

In the case of rotary screen printing presses it is possible to adjust, instead of the exposure unit 32, the doctor blade parameters (contact pressure, setting angle) as a function of the position and speed by means of the signal via the control line 33.1 and an appropriate controller.

1. A printing device, having an electro-photographic arrangement with a photoconductor, to which a drive motor of a photoconductor and an illuminating unit are assigned, wherein the substrate can be conveyed to the electro-photographic unit by means of a conveying device, wherein the photoconductor drive motor can be controlled by means of a control device, and wherein the conveying device can be linearly displaced by means of a drive motor for the conveying device,
characterized in that
the drive motor (15) of the conveying device can be controlled by means of a regulator (14), which is actuated by a master-slave controller (13) via a set value feed line (18.1),
the control device for the drive motor (21) of the photoconductor is also actuated by the master-slave controller (13) via a set value feed line (24.1) by means of a regulator (20), and
the master-slave controller (13) synchronizes the feed speed of the conveying device and the movement speed of the photoconductor.

2. The printing device in accordance with claim 1,
characterized in that
an incremental transducer (23) and/or pulse former (20.1) is assigned to the drive motor (21) of the photoconductor,
the incremental transducer (23) and/or pulse former (20.1) feeds the movement speed of the drive motor of the photoconductor back to the master-slave controller (13) via a signaling path (24.8), and
the signal generated by the incremental transducer (23) and/or the pulse former (20.1) is wired up for controlling the writing speed of the exposure unit (32).

3. The printing device in accordance with claim 2,
characterized in that
the pulse former and/or incremental transducer (20.1 or 23) of the drive motor (21) of the photoconductor feeds a master signal back to the master-slave controller (13) via a signaling path (24.8), and
the master-slave controller (13) controls the drive motor (15) of the conveying device as a function of this master signal.

4. The printing devices in accordance with claim 1,
characterized in that
an incremental transducer pulse former and/or an incremental transducer (14.1 or 17) is assigned to the drive motor (15) of the conveying device,
the pulse former and/or the incremental transducer (14.1 or 17) feeds the motor speed of the drive motor (15) of the conveying device back to the master-slave controller (13) via a signaling path (18.8), and
the signal generated by the pulse former and/or the incremental transducer (14.1 or 17) is wired up for controlling the writing speed of the exposure unit (32).

5. The printing device in accordance with claim 4,
characterized in that
the conveying device feeds a master signal back to the master-slave controller (13), and
the master-slave controller (13) controls the drive motor (21) of the photoconductor as a function of this master signal.

6. The printing device in accordance with one of claims 1 to 4,
characterized in that
the master-slave controller (13) transmits a set value signal (set value signal feed line (18.1, 24.1) to a regulator (14, 20) for controlling the drive motor (15) of the conveying device and/or the drive motor (21) of the photoconductor,
the regulator controls (14, 20) the voltage required for the drive motor (15) of the conveying device and/or the drive motor (21) of the photoconductor, and
a resolver (16, 22) is assigned to the drive motor (15) of the conveying device and/or the drive motor (21) of the photoconductor, which feeds back an actual value motor signal to the master-slave controller (13) via a pulse former or an incremental transducer (14.1, 17, or 20.1, 23).

7. The printing device in accordance with claim 6,
characterized in that
the resolver (16, 22) is electrically coupled with a pulse former (14.1/20.1).

8. The printing device in accordance with claim 6,
characterized in that
the incremental transducer (17, 23) is mechanically coupled with the drive motor (16 and 21).

9. The printing device in accordance with one of claims 1 to 8,
characterized in that
the master-slave controller (13) has an interface for a programming field (12), or its own programming field (12), through which the control parameters can be changed.
